(19) United States
(12) Patent Application Publication
(10) Pub. No.: US 2017/0371157 A1
(43) Pub. Date: Dec. 28, 2017

(54) VIRTUAL REALITY CONTROL DEVICE

(71) Applicant: Indigo Entertainment, Yongin-si (KR)

(72) Inventor: Ju Chul Kim, Suwon-si (KR)

(73) Assignee: Indigo Entertainment, Yongin-si (KR)

(21) Appl. No.: 15/698,253

(22) Filed: Sep. 7, 2017

Related U.S. Application Data
(63) Continuation of application No. PCT/KR2017/000524, filed on Jan. 16, 2017.

(30) Foreign Application Priority Data
Feb. 24, 2016 (KR) 10-2016-0021949

(51) Int. Cl. G02B 27/01; G05G 1/40; G06F 3/01; G06F 3/0346

(52) U.S. Cl. CPC G02B 27/017; G06F 3/0346; G05G 1/40; G06F 3/011

(57) ABSTRACT

The present disclosure relates to a virtual reality control device. The virtual reality control device comprises a pedestal, an upper body supporting element connected to an upper part of the pedestal, a lower body supporting element connected to a lower part of the pedestal, a central shaft whose one end is connected to the pedestal and another end is connected to a central portion of the upper body supporting element, and one or more encoders whose ends are connected to the pedestal and the other ends are connected to the upper body supporting element. The upper body supporting element makes a movement around the central shaft on the basis of a movement of the user, and the one or more encoders detect at least one of a linear displacement, a rotation angular displacement, and a speed depending on the movement of the upper body supporting element to generate first signals.

### CROSS-REFERENCE TO RELATED APPLICATIONS

This application is a continuation application of Patent Cooperation Treaty (PCT) international application Serial No. PCT/KR2017/000524, filed on Jan. 16, 2017, and which designates the U.S., which claims priority to Korean Patent Application Serial No. 10-2016-0021949, filed on Feb. 24, 2016. The entire contents of PCT international application Serial No. PCT/KR2017/000524, and Korean Patent Application Serial No. 10-2016-0021949 are hereby incorporated by reference.

### TECHNICAL FIELD

The present disclosure relates to a virtual reality control device connected to a virtual reality server to control virtual reality contents.

### BACKGROUND

Virtual reality (VR) refers to an interface between a human and a computer that creates specific environment or surroundings as desired with a computer, and enables a user to feel like really interacting with his/her surroundings and environment. In order for the user to feel sense of presence through the virtual reality, information which is obtained through the user's five senses such as sight, hearing, touch, and the like needs to be provided. Particularly, from among the user's senses, sight is the sense that needs the most information, and as virtual reality advances, devices analogous to eyes have been developed. A head-mounted display (HMD) is a device developed as a result of these efforts.

The HMD is a display device worn on the head of a user and is various in kind and principle. The HMD was mainly used in the field of military equipment in the early times, but has become more common as it was used in the field of game. For example, in a current HMD such as the Oculus Rift, when the user turns his/her face to the left, a scene displayed on the screen is moved to the left and when the user turns his/her face to the right, the scene displayed on the screen is moved to the right. That is, the HMD itself recognizes a movement of the user and reflects the movement on the screen. The use of the HMD does not require a physically large operation space and can be flexibly applied so as to be suitable for a specific situation. Korean Patent No. 10-1279869 discloses an apparatus and a method for displaying a flight simulator image using a head-mounted display. Specifically, according to this document, the head-mounted display, i.e., HMD, is applied to the flight simulator and thus improves immersion and a sense of reality that a user feels like really making a flight during an operation of the simulator.

Meanwhile, recently, as the commercial demand for HMD has increased, the demand for relevant virtual reality devices has also increased. In particular, recently, the development of virtual reality devices associated with respective virtual reality contents has been increased in order to provide the user with the utmost virtual reality experience. For example, Korean Patent No. 10-1232422 discloses a motion simulator system for experiencing virtual scuba diving in which a user can experience scuba diving by using virtual reality contents and a motion simulator including a HMD and a headset.

Most of the conventional virtual reality devices are motion-based devices in which when a user performs an operation according to a screen output on a display, a mechanical degree of freedom is used to give the user an experience of motion depending on a situation. For example, Korean Patent No. 10-1501632 discloses an interactive SD rider fly battle racing device, and the device comprises a speaker, a VR headset and a motion base that generates a motion.

Unlike the conventional motion-based virtual reality devices, controller-based devices may be more suitable for experiencing virtual reality of extreme experience contents or flight virtual reality contents. This is because in a controller-based device, when the user moves the device by using his/her body, the movement of the device is reflected in the contents, and, thus, the user can feel like directly controlling the contents. Therefore, there is a need for the controller-based device having a simple mechanical configuration and thus to be efficient in terms of maintenance and management costs.

### SUMMARY

In an exemplary embodiment, the present disclosure generally relates to a virtual reality control device connected to a virtual reality server and configured to control virtual reality contents. The virtual reality control device may comprise a pedestal, an upper body supporting element connected to an upper part of the pedestal and configured to support an upper body of a user, and a lower body supporting element connected to a lower part of the pedestal and configured to support a lower body of the user. Further, the virtual reality control device may comprise a central shaft configured to bear at least the weight of the user and the upper body supporting element, wherein one end of the central shaft may be connected to the pedestal and another end may be connected to a central portion of the upper body supporting element. The virtual reality control device may further comprise one or more encoders configured to detect a movement of the upper body supporting element as the user moves, wherein one end of the encoder may be connected to the pedestal and another end of the encoder may be connected to the upper body supporting element. The upper body supporting element can make a movement around the central shaft on the basis of a movement of the user, and the one or more encoders may detect at least one of a linear displacement, a rotation angular displacement, and a speed depending on the movement of the upper body supporting element to generate first signals for controlling the virtual reality contents.

In another exemplary embodiment, the virtual reality control device may further comprise an upper body supporting element fixing device. When the virtual reality control device does not operate, the upper body supporting element fixing device fixes the upper body supporting element, and when the virtual reality control device starts operating, the upper body supporting element fixing device is separated from the upper body supporting element and thus enables the user to freely swing the upper body supporting element to the left and the right.

In yet another exemplary embodiment, the upper body supporting element may comprise a plurality of arm supporting elements, a plurality of arm adjusting levers, and a plurality of fixing handles. The arm supporting elements are elements on which the user puts his/her arms. The user can adjust at least one of the lengths or angles of the arm supporting elements to be suitable for his/her physical condition with the arm adjusting levers connected to the arm supporting elements. The fixing handles are elements connected to the arm adjusting levers so as to be gripped with his/her hands. The fixing handle may comprise a fixing handle button. When the user pushes the button with his/her finger, a signal is generated to perform a desired function from among the virtual reality contents.

The upper body supporting element may further comprise a body safety guide. The body safety guide suppresses separation of the upper body of the user from the device when the user moves his/her body.

In still another exemplary embodiment, the lower body supporting element may comprise a knee saddle, one or more supports, and a foot holder. The user may put his/her knees on the knee saddle to distribute his/her weight, and the one or more supports between the knee saddle and the pedestal support the knee saddle to have an appropriate height. Further, the user may fix his/her ankles with the foot holder. The lower body supporting element may further comprise a foot holder adjusting lever. The foot holder adjusting lever adjusts the thickness for holding the user's ankles so as to be suitable for the user's physical condition. The lower body supporting element may further comprise a foot pedal. The foot pedal is connected to the foot holder, and, thus, when the user presses the foot pedal with his/her foot, a signal is generated to perform a desired function from among the virtual reality contents. Meanwhile, the pedestal may comprise a rail. The rail may enable at least one of the foot holder and the supports to be slidable.

The foregoing summary is illustrative only and is not intended to be in any way limiting. In addition to the illustrative aspects, embodiments, and features described above, further aspects, embodiments, and features will become apparent

### BRIEF DESCRIPTION OF THE DRAWINGS

The foregoing and other features of the present disclosure will become more fully apparent from the following description and appended claims, with reference to the accompanying drawings. These drawings depict only several exemplary embodiments in accordance with the disclosure and are, therefore, not to be considered limiting of its scope. The disclosure will be described with additional specificity and detail through use of the accompanying drawings.

FIG. 1 illustrates a virtual reality control device and a basic posture of a user;

FIG. 2A shows a front view of a virtual reality control device;

FIG. 2B shows a plane view of the virtual reality control device;

FIG. 2C shows a perspective view of the virtual reality control device;

FIGS. 3A and 3B illustrate an upward posture and a downward posture of the user using the virtual reality control device;

FIG. 4 illustrates a configuration that implements a virtual reality system including a virtual reality control device; and

FIG. 5 illustrates a configuration that implements a virtual reality system using two or more virtual reality control devices.

### DETAILED DESCRIPTION

In the following detailed description, reference is made to the accompanying drawings, which form a part hereof. In the drawings, similar symbols typically identify similar components unless context dictates otherwise. The illustrative embodiments described in the detailed description, drawings, and claims are not meant to be limiting the claims. Other embodiments may be utilized, and other changes may be made, without departing from the scope and spirit of the subject matter presented herein. It will be readily understood that the aspects of the present disclosure, as generally described herein and illustrated in the drawings, can be arranged, substituted, combined, separated, and designed in a wide variety of different configurations, all of which are explicitly contemplated herein.

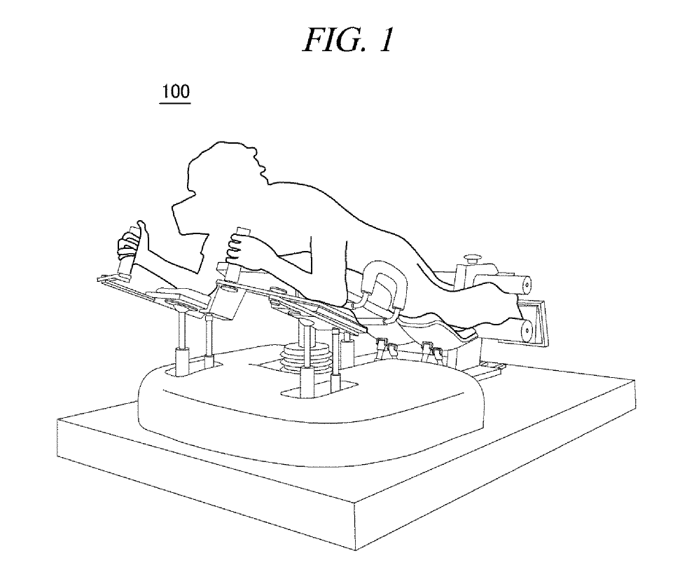

FIG. 1 illustrates a virtual reality control device 100 and a basic posture of a user. The present disclosure generally relates to a virtual reality control device connected to a virtual reality server to control virtual reality contents. The virtual reality contents may include extreme experience contents or flight virtual reality contents. Unlike the conventional motion-based virtual reality devices, the virtual reality control device is a controller which a user directly moves his/her body so that the user feels like the user's body and the virtual reality control device are integrated with each other. That is, in FIG. 1, the user wearing a head-mounted display (HMD) may fix his/her ankles and let his/her knees be supported and thus may feel stable, and has a basic posture on the virtual reality control device while laying his/her upper body down on an upper body supporting element and gripping fixing handles with his/her hands. In the basic posture, an upper body supporting element fixing device supports the upper body supporting element while being in contact with the upper body supporting element in order for the user to easily ride the device. Details thereof will be described later. If an operation is started, the user may experience virtual reality contents by leaning his/her upper body to the left and the right, pulling his/her upper body or downwardly pushing his/her upper body together with the virtual reality control device. The user may push a fixing handle button connected to an upper part of the fixing handle with his/her finger or press a foot pedal with his/her foot so as to generate a signal and perform an additional function from among the virtual reality contents.

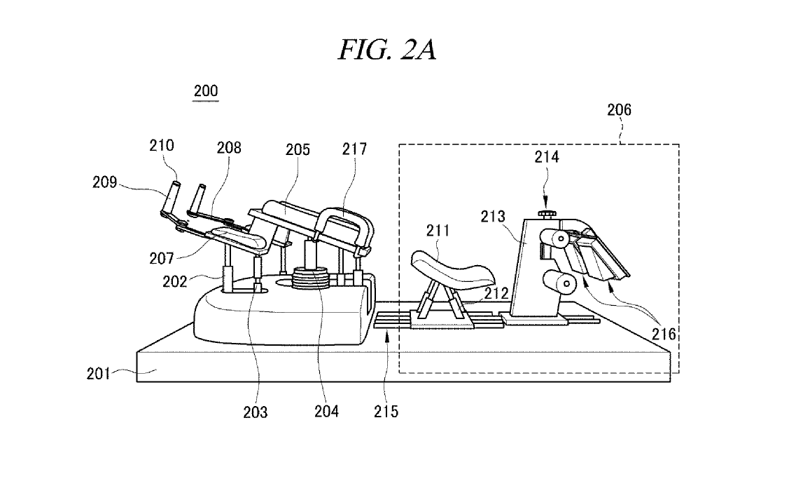

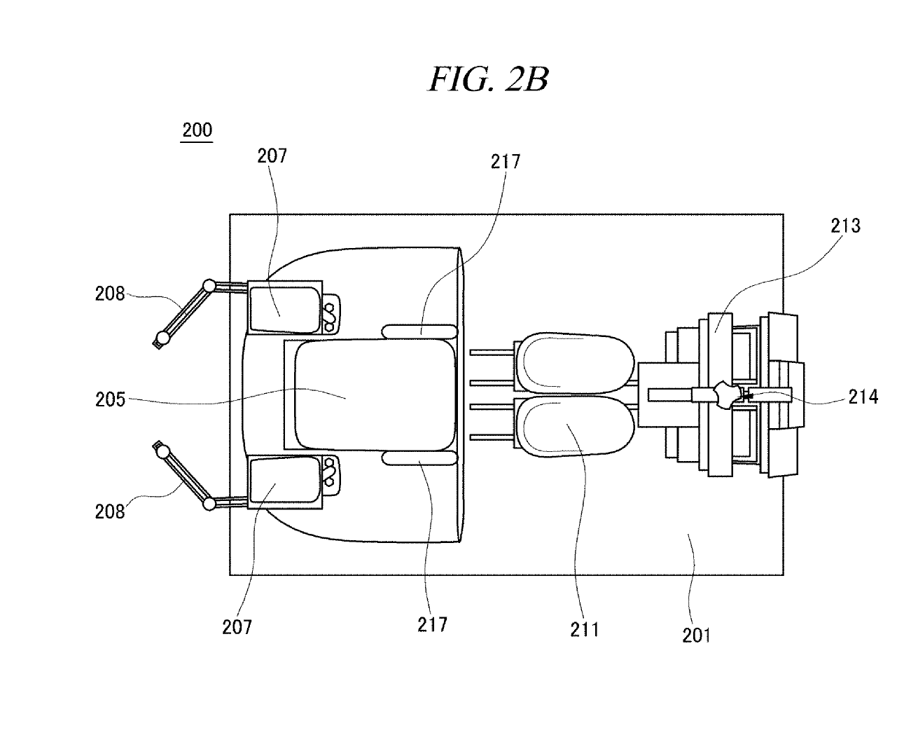

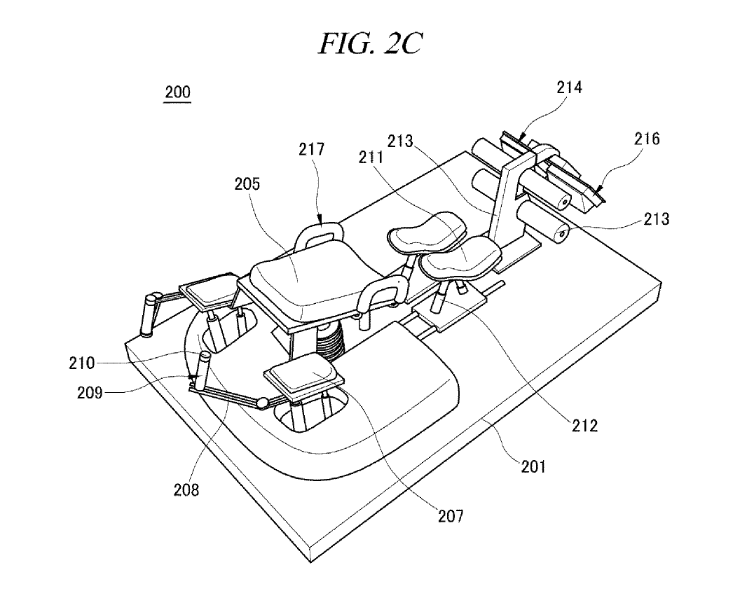

FIG. 2A shows a front view of a virtual reality control device 200, FIG. 2B shows a plane view of the virtual reality control device 200, and FIG. 2C shows a perspective view of the virtual reality control device 200. In FIG. 2A to FIG. 2C, the same components are assigned the reference numerals, respectively. Hereinafter, each component of the virtual reality control device 200 will be described in detail on the basis of FIG. 2A to FIG. 2C.

As illustrated in FIG. 2A to FIG. 2C, the virtual reality control device 200 may comprise a pedestal 201, one or more encoders 202, a central shaft 204, an upper body supporting element 205 configured to support an upper body of a user, a lower body supporting element 206 configured to support a lower body of the user.

The pedestal 201 may be manufactured into a proper shape and size using a proper material so as to bear the whole weight of the device and the user. In FIG. 2A to FIG. 2C, the pedestal 201 is illustrated as having a size and shape for stably fixing all of the components of the virtual reality control device 200 and bearing the weight thereof, but in some exemplary embodiments, some components may not be connected on the pedestal 201 but may be directly fixed on the ground. The upper body supporting element 205 and the lower body supporting element 206 may have a shape and size suitable for supporting the body of the user.

One end of the central shaft 204 is connected to the pedestal 201, and another end is connected to a central portion of the upper body supporting element 205, and, thus, the central shaft 204 can bear at least the weight of the user and the upper body supporting element 205. The central shaft 204 may be equipped with a pneumatic shock absorber. The pneumatic shock absorber system can adjust a pressure of a shock absorber in the range of from 30 kg to 90 kg. When the user relaxes on the virtual reality control device 200 after finishing movement, he/she can return to the basic posture by the action of the central shaft 204. Further, the central shaft 204 can provide the best riding quality to the user considering the weight of the user.

Ends of the one or more encoders 202 may be connected to the pedestal 201 and the other ends may be connected to the upper body supporting element 205 so as to be operable. In an example, the one or more encoders 202 may be three encoders that may be respectively connected to an upper left side, an upper right side, and a lower center of the upper body supporting element 205 so as to be operable. The one or more encoders 202 is highly durable against shock and vibration of the virtual reality control device 200 and thus improves the stability. The one or more encoders 202 may detect at least one of a linear displacement, a rotation angular displacement, and a speed depending on a movement of the upper body supporting element 205 to generate first signals for controlling virtual reality contents. In an example, the first signals generated in the encoder 202 may be transmitted to a virtual reality server (not illustrated) communicatively connected to the virtual reality control device 200. The virtual reality server may perform a micro control to the virtual reality contents on the basis of the first signals and calculate a horizontal value of contents stored in the virtual reality server by using an average value of the first signals.

In an exemplary embodiment, the one or more encoders 202 may be linear shaft encoders. That is, the one or more encoders 202 are digital position sensors capable of simultaneously performing a function of a linear encoder configured to measure a linear displacement and a function of a shaft encoder configured to measure a rotation angular displacement. The one or more encoders 202 may comprise a high-strength steel shaft including a completely integrated scale and a sliding read head module without including a movable part therein. Meanwhile, the one or more encoders 202 can be implemented in various ways so as to be cost effective compared to the case where the linear shaft encoders are used and to measure both the linear displacement and the rotation angular displacement. For example, in another exemplary embodiment, the one or more encoders 202 may include one or more linear encoders configured to measure a linear displacement and one or more rotation encoders configured to measure a rotation angular displacement. In this exemplary embodiment, a linear encoder configured to measure a linear displacement and a rotation encoder configured to measure a rotation angular displacement are used together instead of a linear shaft encoder capable of measuring both a linear displacement and a rotation angular displacement. Since the linear shaft encoder is relatively expensive, it may be a cost-effective way to use the linear encoder together with the rotation encoder as compared to the case where the linear shaft encoder is used. In yet another exemplary embodiment, the one or more encoders 202 may be implemented with the linear encoders only instead of the linear shaft encoders and a gyro sensor may be separately employed in the upper body supporting element 205. In this exemplary embodiment, a linear displacement is measured by the linear encoders and a rotation angular displacement is measured by the gyro sensor combined with the upper body supporting element 205. Herein, the gyro sensor may be coupled to the upper body supporting element 205 in various manners such as a detachable manner and a fixed manner, and the gyro sensor just needs to measure a rotation angular displacement depending on a movement of the user as being coupled to the upper body supporting element 205. The above-described various exemplary embodiments for implementing the encoders 202, i.e., the encoders 202 implemented with the linear shaft encoders only, the encoders 202 implemented with the linear encoder and the rotation encoder, and/or the encoders 202 implemented with the linear encoders in addition to the gyro sensor, may be implemented using various available methods known in the art. Further, these exemplary embodiments are provided for illustration purposes only, and various other methods for measuring both a linear displacement and a rotation angular displacement depending on a movement of the user riding on the upper body supporting element 205 can be adopted in the one or more encoders 202 within a technical concept of the present disclosure.

The upper body supporting element 205 may comprise a plurality of arm supporting elements 207, a plurality of arm adjusting levers 208, and a plurality of fixing handles 209. The plurality of arm supporting elements 207 are located on both upper sides of the upper body supporting element 205 so as to support a left arm and a right arm, respectively. At least one of the length and angle of each of the plurality of arm adjusting levers 208 can be adjusted to be suitable for the user's physical condition, and ends of the plurality of arm adjusting levers 208 are connected to the plurality of arm supporting elements 207, respectively. The plurality of fixing handles 209 may be connected to the other ends of the plurality of arm adjusting levers 208, respectively. The user may assume an operational posture while gripping the plurality of fixing handles 209 with his/her left hand and right hand. The fixing handles 209 may comprise a plurality of fixing handle buttons 210 respectively connected thereto. The plurality of fixing handle buttons 210 may generate second signals for controlling virtual reality contents. In an exemplary embodiment, the second signals generated in the fixing handle buttons 210 may be transmitted to the virtual reality server (not illustrated) communicatively connected to the virtual reality control device 200. The virtual reality server may perform general operations such as start and stop within the virtual reality contents on the basis of the second signals.

The upper body supporting element 205 may further comprise a body safety guide 217. The body safety guide is configured to suppress separation of the user when the user moves his/her body to the left and the right. At least one of the height and width of the body safety guide 217 can be adjusted to be suitable for the user's body.

In another exemplary embodiment, the lower body supporting element 206 may comprise a knee saddle 211, one or more supports 212, a foot holder 213, and a foot holder adjusting lever 214. Ends of the one or more supports may be connected to the pedestal 201 and the other ends of the one or more supports may be connected to the knee saddle 211. The knee saddle 211 may have any configuration capable of supporting the users' knees and bearing the user's weight. The foot holder 213 may be connected to a lower part of the pedestal. The user may fix his/her ankles with the foot holder. The foot holder adjusting lever 214 may be coupled to the foot holder 213 and a position thereof may be adjusted depending on the user's ankle thickness. For example, if the user puts his/her ankles between an upper part and a lower part of the foot holder 213 and turns the foot holder adjusting lever 214, the lower part of the foot holder 213 is brought into contact with the ankles on the front side of the body and the upper part of the foot holder 213 is brought into contact with the ankles on the back side of the body so as to hold the user's ankles. Although it has been illustrated that a position of the foot holder 213 is changed by turning the foot holder adjusting lever 214, the foot holder 213 may be implemented to be automatically adjusted to be suitable for the user's ankles.

The pedestal 201 may further comprise a rail 215. FIG. 2A shows an example where the rail 215 is installed. The one or more supports 212 may be slidable on the rail 215 of the pedestal 201. The foot holder 213 may be adjusted depending on the physical condition through the rail 215, but a position of the foot holder 213 may be fixed during an operation. The foot holder 213 may comprise a foot pedal 216. The foot pedal 216 may generate a third signal for controlling the virtual reality contents. In an exemplary embodiment, the third signal generated in the foot pedal 216 may be transmitted to the virtual reality server (not illustrated) communicatively connected to the virtual reality control device 200. The third signal is generated when the user presses the foot pedal 216, and the virtual reality server may perform operations such as acceleration, deceleration, and left and right turn within the virtual reality contents on the basis of the third signal.

The virtual reality control device 200 may further comprise an upper body supporting element fixing device 203. One end of the upper body supporting element fixing device 203 is connected to the pedestal 201. Another end of the upper body supporting element fixing device 203 may support the upper body supporting element 205 while being in contact with the upper body supporting element 205 when the virtual reality control device 200 is in a standby state, and may be separated from the upper body supporting element 205 when the virtual reality control device starts operating. Therefore, while the virtual reality control device 200 is not used, the upper body supporting element fixing device 203 can stably support the upper body supporting element 205, which prevents the occurrence of trouble and enables the user to stably ride thereon.

In an exemplary embodiment, the user may control the virtual reality contents stored in the virtual reality server by moving his/her body while being on the virtual reality control device 200. For example, if the user on the virtual reality control device 200 grips the left fixing handle with the left hand and grips the right fixing handle with the right handle and then moves his/her own body to the left and the right, first signals generated by the one or more encoders 202 in response to this movement are transmitted to the virtual reality server, and the virtual reality server provides the user with an image of turning to the left and the right in the virtual reality contents (e.g., flight virtual reality contents) through a HMD. In the flight virtual reality contents, it is possible to more realistically provide the user with the upward and downward movement as well as the movement to the left and the right.

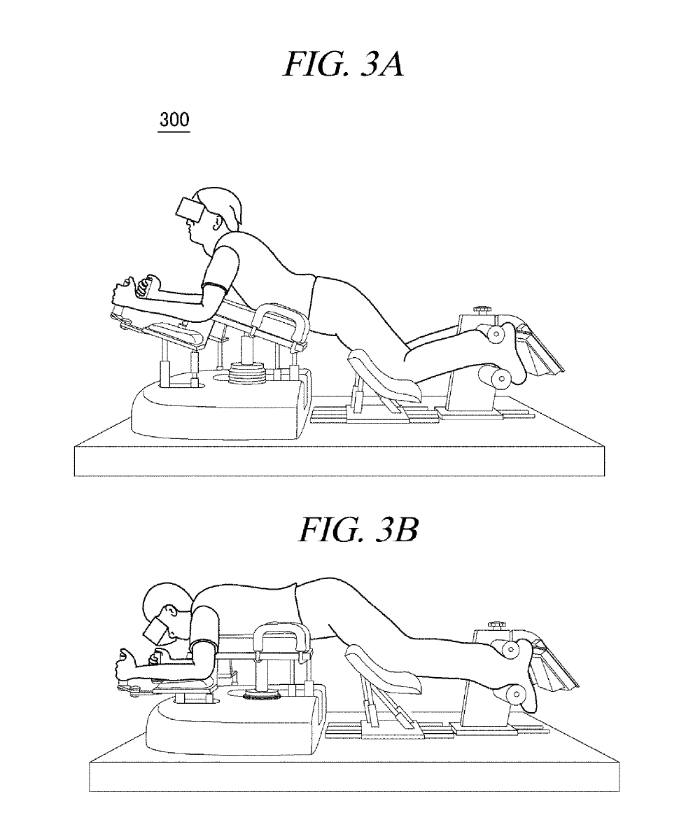

FIGS. 3A and 3B illustrate an upward posture and a downward posture of the user on the virtual reality control device. When the user on the virtual reality control device moves his/her upper body upwardly while pulling the both fixing handles to the body, he/she can move upwardly within the virtual reality contents. Further, when the user on the virtual reality control device applies force downwardly to the upper body supporting element using his/her upper body while pushing the both fixing handles forward, he/she can move downwardly within the virtual reality contents. In an exemplary embodiment, the one or more supports are slidable on the rail of the pedestal and thus enable the user to easily assume the upward posture and the downward posture. That is, in the upward posture, the user may pull the one or more supports to the upper body while bending his/her knees in order for the user to easily raise the upper body. On the other hand, in the downward posture, the user may straighten the knees while bending his/her upper body, and, thus, the one or more supports slide on the rail so as to be adjusted to a proper position.

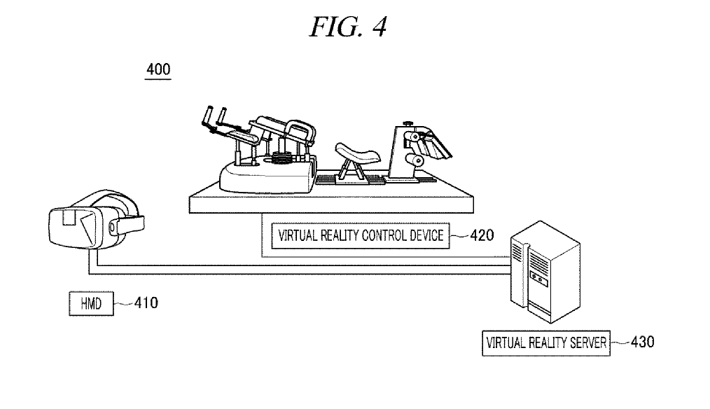

FIG. 4 illustrates a configuration that implements a virtual reality system 400. The virtual reality system 400 comprises a HMD 410, a virtual reality control device 420, and a virtual reality server 430, but may not be limited thereto. Further, each of the HMD 410 and the virtual reality control device 420 is communicatively connected to the virtual reality server 430. They may be connected via wired or wireless connection and can be connected using various available methods widely known in the art.

The HMD 410 may include various types of devices being or to be developed and may be mounted on the user's head to provide the user with sight and/or hearing, and other stimuli available in an experience of virtual reality contents. A widely used device is basically configured to provide video and audio data to a user, and such video and audio data can be received by the HMD 410 from the virtual reality server 430 and then provided to the user through a display and a speaker comprised in the HMD 410. The HMD 410 may also be an interactive device capable of receiving a user input such as the user's voice and transmitting the user input to the virtual reality server 430 to control the virtual reality contents.

The virtual reality control device 420 may be the virtual reality control device described above with reference to FIG. 1 to FIG. 3B. Basically, the user rides on the virtual reality control device 420 and moves his/her body, and the virtual reality control device 420 generates control signals (e.g., the first signal, second signal, and third signal described with reference to FIG. 2) depending on the movement of the user. The control signals generated by the virtual reality control device 420 may be transmitted to the virtual reality server 430, and the transmitted control signals may be used in controlling the virtual reality contents that are stored and processed in the virtual reality server 430.

The virtual reality server 430 is a device to process the virtual reality contents and includes at least basic hardware components such as a memory, a processor, and the like. When the virtual reality contents are processed, the virtual reality server 430 may receive the control signals transmitted from the virtual reality control device 420, control the virtual reality contents on the basis of the control signals, and transmit video and/or audio signals depending on a result of the control to the HMD 410. Although not illustrated in FIG. 4, the virtual reality system 400 may further comprise, for example, a wind generating device and a water spraying device depending on contents processed in the virtual reality server 430.

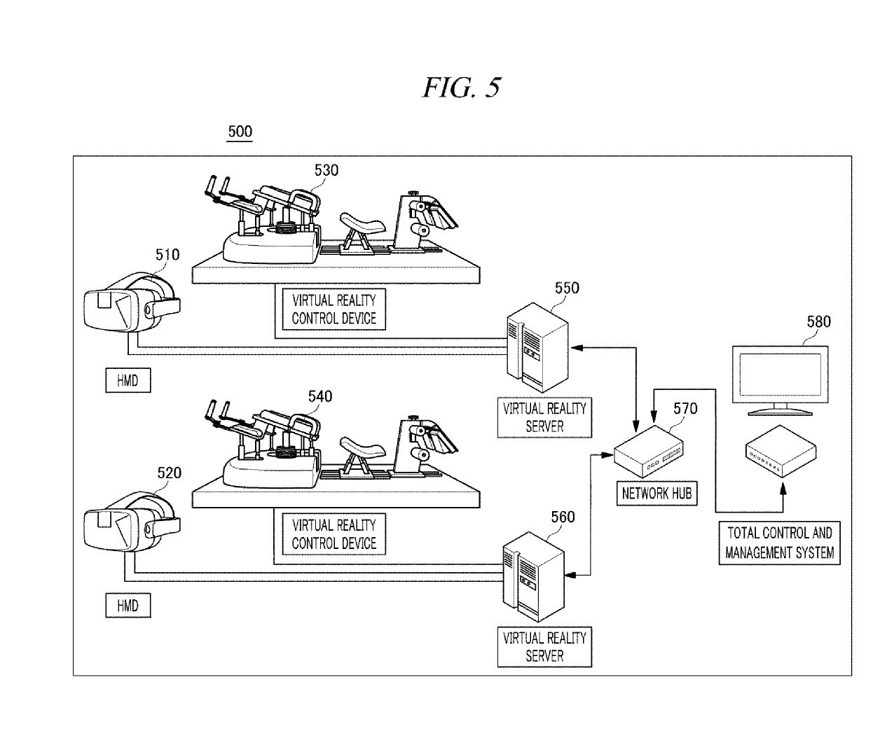

FIG. 5 illustrates a configuration that implements a virtual reality system 500 using two or more virtual reality control devices. The virtual reality system 500 may comprise two or more HMDs 510 and 520, two or more virtual reality control devices 530 and 540, two or more virtual reality servers 550 and 560, a network hub 570, and a total control and management system 580. FIG. 5 illustrates that two HMDs, two virtual reality control devices, and two virtual reality servers are comprised, but may not be limited thereto.

The HMDs 510 and 520 and the virtual reality control devices 530 and 540 are respectively communicatively connected to the virtual reality servers 550 and 560. They may be connected via wired or wireless connection and can be connected using various available methods widely known in the art. The HMDs 510 and 520, the virtual reality control devices 530 and 540, and the virtual reality servers 550 and 560 may be similar to the HMD 410, the virtual reality control device 420, and the virtual reality server 430 illustrated in FIG. 4 in function and details, and a detailed explanation thereof will be omitted for brevity in explanation.

The network hub 570 may connect the virtual reality servers 550 and 560 and the total control and management system 580 with, desirably, a cable to constitute a LAN which is a local area network. The network hub 570 performs a data relay function by transmitting data from the virtual reality servers 550 and 560 to the total control and management system 580 and from the total control and management system 580 to the virtual reality servers 550 and 560. The total control and management system 580 may control and manage the plurality of virtual reality servers 550 and 560 through the network hub. The total control and management system 580 may enable users of the virtual reality control devices 530 and 540 to play a single game and/or battle game through the virtual reality servers 550 and 560 depending on virtual reality contents. Although the virtual reality system 500 is implemented using the two virtual reality control devices 530 and 540, those skilled in the art may also implement a virtual reality system including three or more virtual reality control devices as well as a total control and management system and a network hub.

Through the whole document, it has been noted that the uses of plural and singular terms should be distinguished from each other, but it is to be understood that any reference in plural form may refer to a single element and any reference in singular form may refer to multiple elements. Further, the term “connected to” or “coupled to” that is used to designate a connection or coupling of one element to another element includes both a case that an element is “directly connected or coupled to” another element and a case that an element is “indirectly connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise and is not intended to preclude the possibility that one or more other features, numbers, steps, operations, components, parts, or combinations thereof may exist or may be added. Furthermore, in those instances where a convention analogous to “at least one of A, B, and C, etc.” is used, in general such a construction is intended in the sense those skilled in the art would understand the convention (e.g., “a system having at least one of A, B, and C” would include but not be limited to systems that have A alone, B alone, C alone, A and B together, A and C together, B and C together, and/or A, B, and C together, etc.).

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims and the full scope of equivalents to which such claims are entitled. It is to be understood that the present disclosure is not limited to a specific method, synthesis, or composition which may, of course, vary. Further, it is also to be understood that the terminology used herein is for the purpose of describing particular embodiments only, and is not intended to be limiting.

While various embodiments of the present disclosure have been disclosed herein for purposes of illustration, it will be acknowledged that various modification can be made without departing from the scope and spirit of the present disclosure. Therefore, the various embodiments disclosed herein are not intended to be limiting, with the true scope and spirit being indicated by the following claims.

We claim:

1. A virtual reality control device connected to a virtual reality server and configured to control virtual reality contents, comprising:
a pedestal;
an upper body supporting element connected to an upper part of the pedestal and configured to support an upper body of a user;
a lower body supporting element connected to a lower part of the pedestal and configured to support a lower body of the user;
a central shaft of which one end is connected to the pedestal and another end is connected to a central portion of the upper body supporting element to bear at least a weight of the user and the upper body supporting element; and
one or more encoders, wherein one end of each of the one or more encoders is connected to the pedestal and another end of each of the one or more encoders is connected to the upper body supporting element, respectively,
wherein the upper body supporting element makes a movement around the central shaft on the basis of a movement of the user, and the one or more encoders detect at least one of a linear displacement, a rotation angular displacement, and a speed depending on the movement of the upper body supporting element to generate first signals for controlling the virtual reality contents.

2. The virtual reality control device of claim 1,
wherein the upper body supporting element comprise a plurality of arm supporting elements, a plurality of arm adjusting levers, and a plurality of fixing handles,
the plurality of arm supporting elements are located on both upper sides of the upper body supporting element,
at least one of the length or angle of each of the plurality of arm adjusting levers is adjustable, and one end of each of the plurality of arm adjusting levers is connected to the plurality of arm supporting elements, respectively, and
each of the plurality of fixing handles is connected to another end of each of the plurality of arm adjusting levers.

3. The virtual reality control device of claim 2,
wherein the upper body supporting element further comprises a plurality of fixing handle buttons connected to the plurality of fixing handles, respectively, and
the plurality of fixing handle buttons generate second signals for controlling the virtual reality contents.

4. The virtual reality control device of claim 1, further comprising:
an upper body supporting element fixing device,
wherein one end of the upper body supporting element fixing device is connected to the pedestal, and another end of the upper body supporting element fixing device supports the upper body supporting element while being in contact with the upper body supporting element when the virtual reality control device is in a standby state, and is separated from the upper body supporting element when the virtual reality control device is in an operational state.

5. The virtual reality control device of claim 1,
wherein the lower body supporting element comprises a knee saddle, one or more supports, a foot holder, and a foot holder adjusting lever,
ends of the one or more supports are connected to the pedestal, the other ends of the one or more supports are connected to the knee saddle, the foot holder is connected to a lower part of the pedestal, and the foot holder adjusting lever is combined with the foot holder to adjust a position of the foot holder.

6. The virtual reality control device of claim 5,
wherein the pedestal comprises a rail, and
the one or more supports are connected to be slidable on the rail of the pedestal.

7. The virtual reality control device of claim 5,
wherein the foot holder comprises a foot pedal, and
the foot pedal generates a third signal for controlling the virtual reality contents.

8. The virtual reality control device of claim 1,
wherein the upper body supporting element further comprises a body safety guide, and
the body safety guide is fixedly connected to the upper body supporting element to suppress separation of the user.

9. The virtual reality control device of claim 1,
wherein the one or more encoders are linear shaft encoders.

10. The virtual reality control device of claim 1,
wherein the one or more encoders comprise one or more linear encoders and one or more rotation encoders.

11. The virtual reality control device of claim 1,
wherein the upper body supporting element comprises a gyro sensor, and
the one or more encoders comprise one or more linear encoders.

12. The virtual reality control device of claim 1, further comprising:
a signal transmission element,
wherein the signal transmission element transmits the first signals to the virtual reality server.
